(19) United States
(12) Patent Application Publication
(10) Pub. No.: US 2024/0399858 A1
(43) Pub. Date: Dec. 5, 2024

(54) Electric Motor Drive Train Conversion Assembly

(71) Applicant: BH Electrics LLC, Lancaster, PA (US)

(72) Inventor: Brandon Hollinger, Lancaster, PA (US)

(73) Assignee: BH Electrics LLC, Lancaster, PA (US)

(21) Appl. No.: 18/328,326

(22) Filed: Jun. 2, 2023

(51) Int. Cl. B60K 17/24

(52) U.S. Cl. CPC B60K 17/24

(57) ABSTRACT

A drive train conversion assembly is provided and generally includes an end member, a joining member, a connection member and a spline member. The joining member is positioned abutting an upper portion of the end member, and the connection member is coupled to an upper portion of the joining member. The spline member is connected to the connection member and includes a plurality of teeth marrying a universal key receiver of a spider cage.

### FIELD OF THE INVENTION

The present invention relates to an electric motor drive train conversion assembly and, more particularly, to an electric motor drive train conversion assembly for converting a gas powered motor vehicle to an electric powered motor vehicle.

### BACKGROUND

As a general matter, electric vehicles are on the rise as the world shifts towards electric vehicles. However, a consumer purchasing an electric vehicle runs into numerous problems such as price, size of the vehicle and lack of power. Additionally, if the consumer prefers to own both an electric vehicle and a gas powered vehicle (see FIG. 1), the consumer endures a major expense. Therefore, there is a need for a universal kit for converting a common gas powered vehicle into an electric vehicle.

It is desirable to provide a solution for converting an ordinary gas powered vehicle into an electric vehicle without the major expenses.

As the foregoing illustrates, the invention provides an electric motor drive train conversion assembly as provided below.

### SUMMARY

A drive train conversion assembly is provided and generally includes an end member, a joining member, a connection member and a spline member. The joining member is positioned abutting an upper portion of the end member, and the connection member is coupled to an upper portion of the joining member. The spline member is connected to the connection member and includes a plurality of teeth marrying a universal key receiver of a spider cage.

### BRIEF DESCRIPTION OF DRAWINGS

In the following, the present invention is described in more detail with references to the drawings in which:

FIG. 1 is a schematic diagram of a known gas powered vehicle;

FIG. 2 is a schematic diagram of an electric powered vehicle with the inclusion of a drive train conversion assembly according to the invention;

FIG. 3 is a perspective view of a drive train conversion assembly according to the invention;

FIG. 4 is a front view of a conversion assembly of the drive train conversion assembly according to the invention;

FIG. 5 is a top view of FIG. 4;

FIG. 6 is a bottom view of FIG. 5;

FIG. 7 is a perspective view of a stabilizer of the drive train conversion assembly according to the invention;

FIG. 8 is a side view of FIG. 7;

FIG. 9 is a rear view of FIG. 7;

FIG. 10 is a front view of FIG. 7;

FIG. 11 is a perspective view showing assembly of drive train conversion assembly according to the invention with a known electrical engine;

FIG. 12 is another perspective view showing assembly of drive train conversion assembly according to the invention with a known electrical engine;

FIG. 13 is an exploded perspective view of a drive train conversion assembly according to the invention with a portion of a known electrical engine;

FIG. 14 is a front perspective view showing assembly of drive train conversion assembly according to the invention with a known differential;

FIG. 15 is a rear perspective view of FIG. 14;

FIG. 16 illustrates a cross sectional view of FIG. 15 along line 14-14; and

FIG. 17 is another perspective view showing assembly of drive train conversion assembly according to the invention with a known electrical engine.

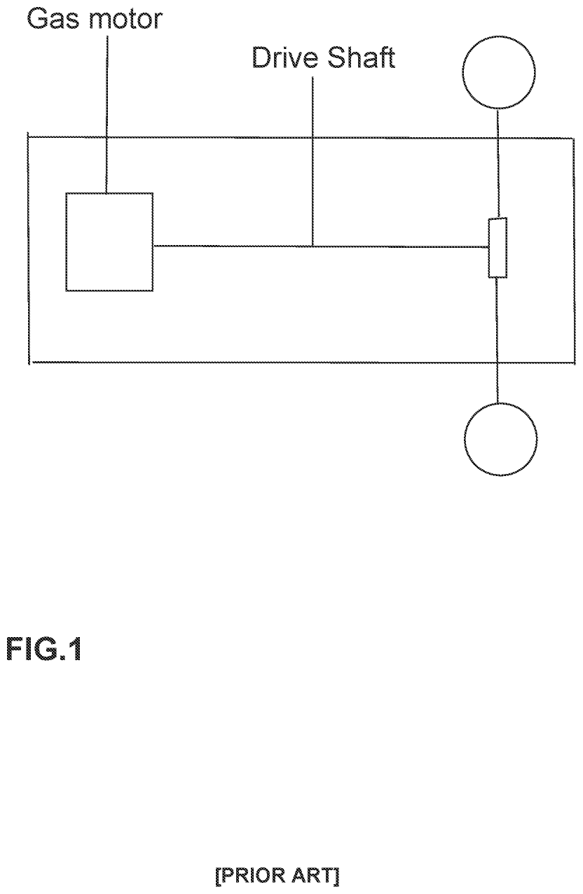

### DETAILED DESCRIPTION OF THE EMBODIMENTS

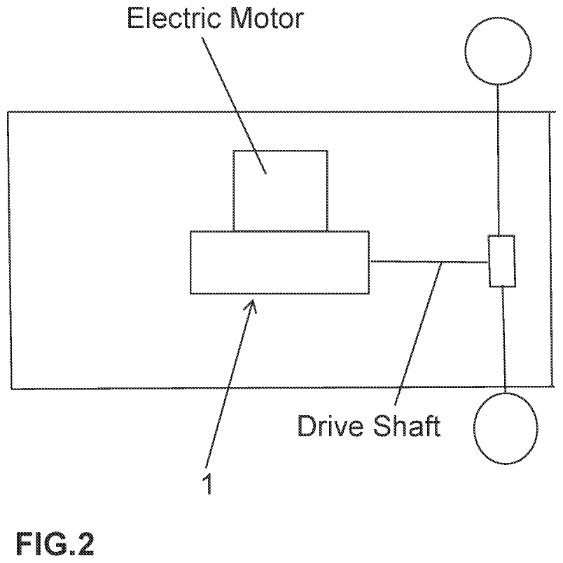

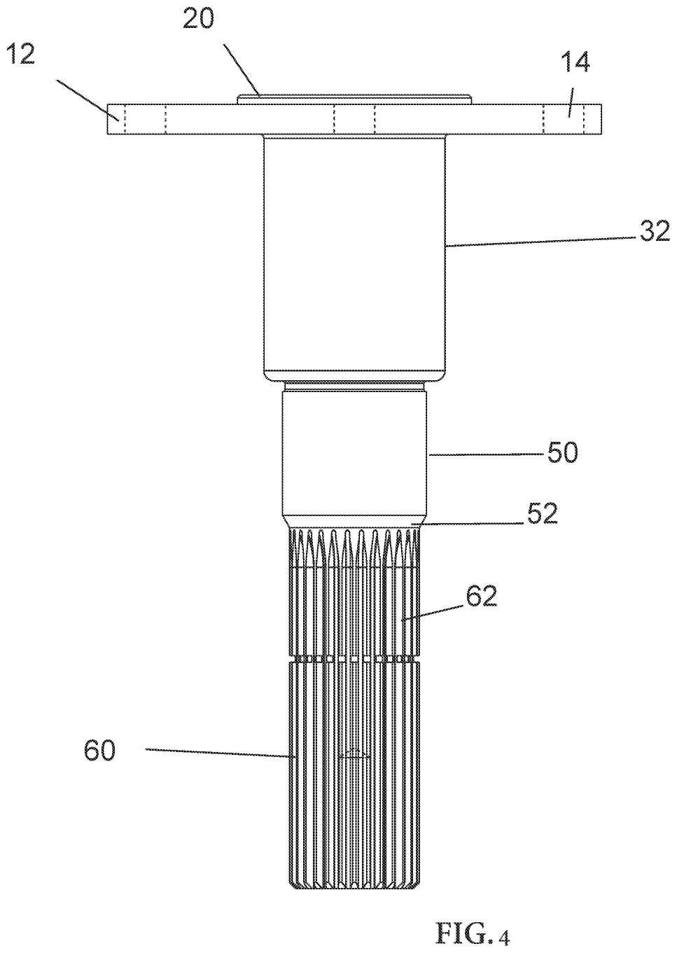

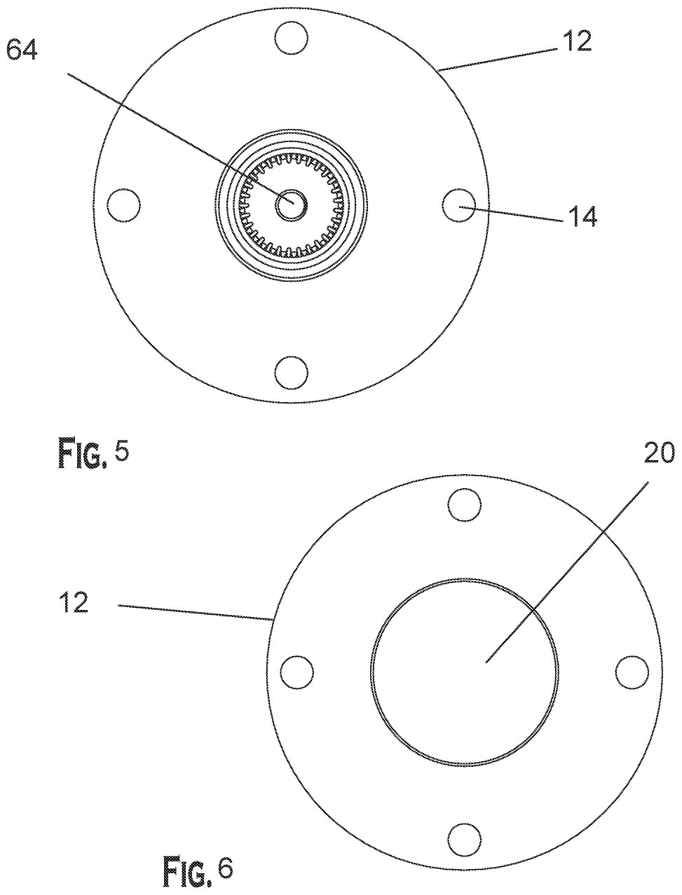

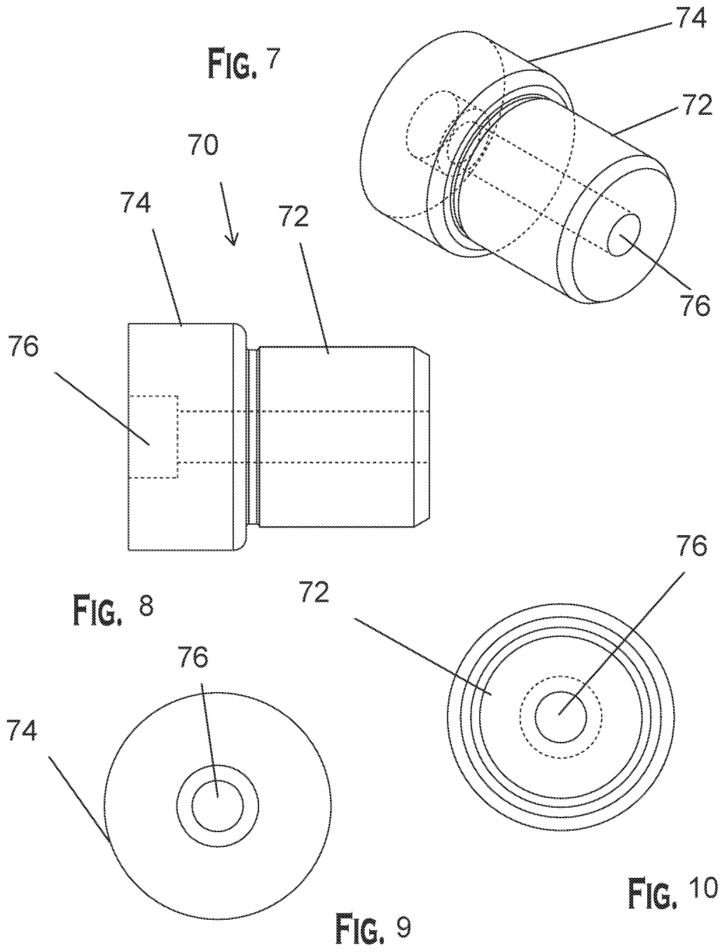

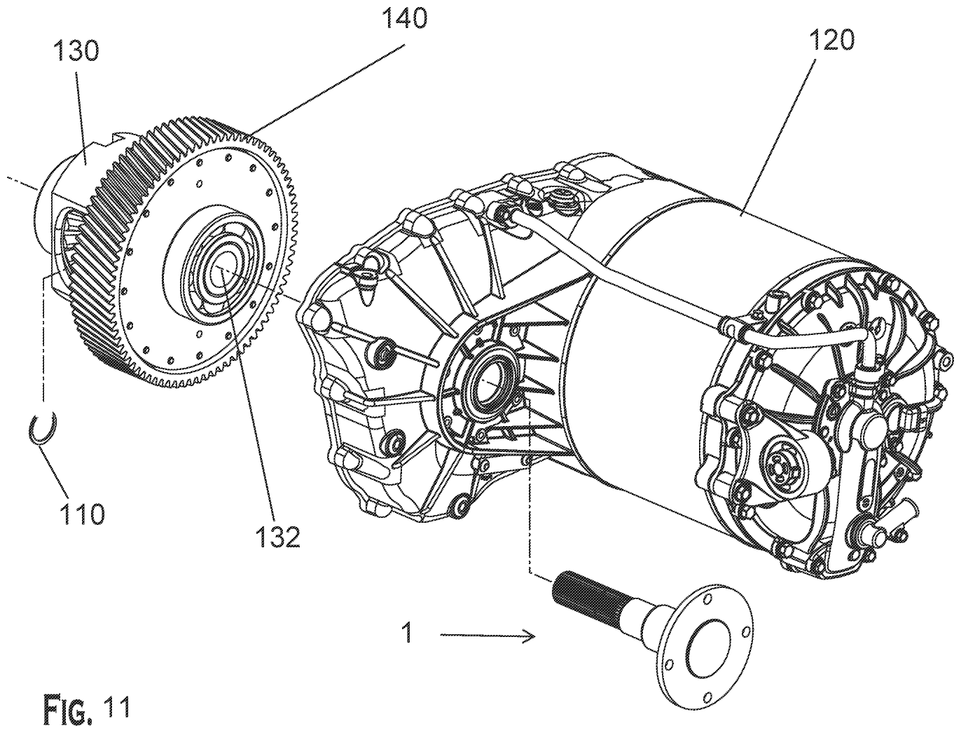

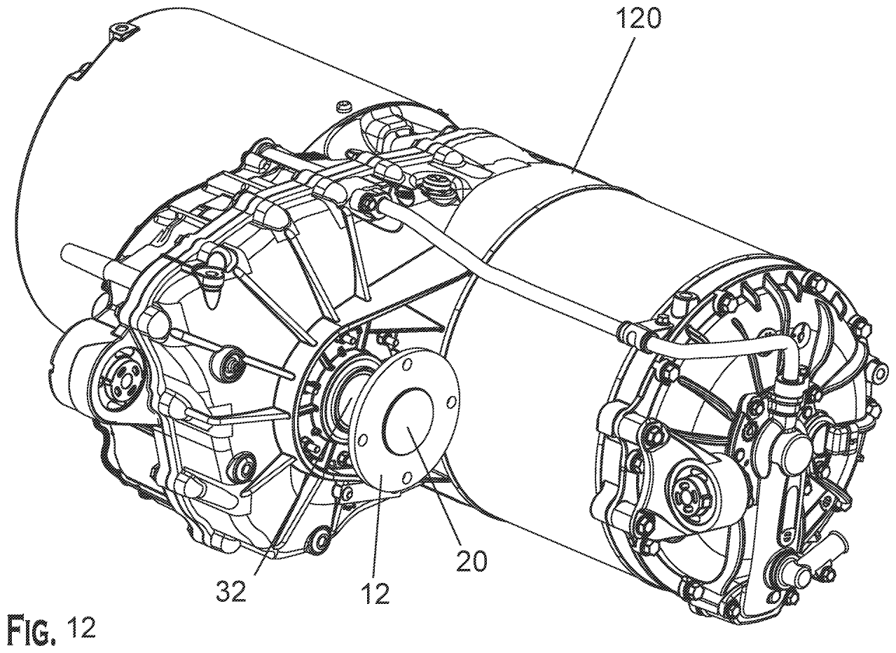

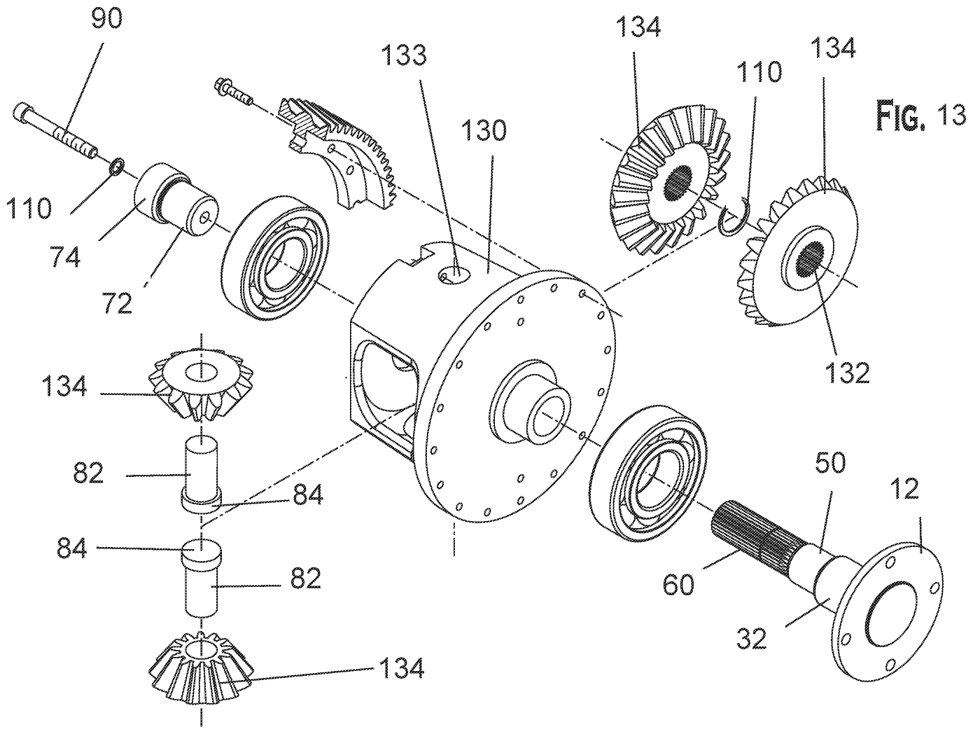

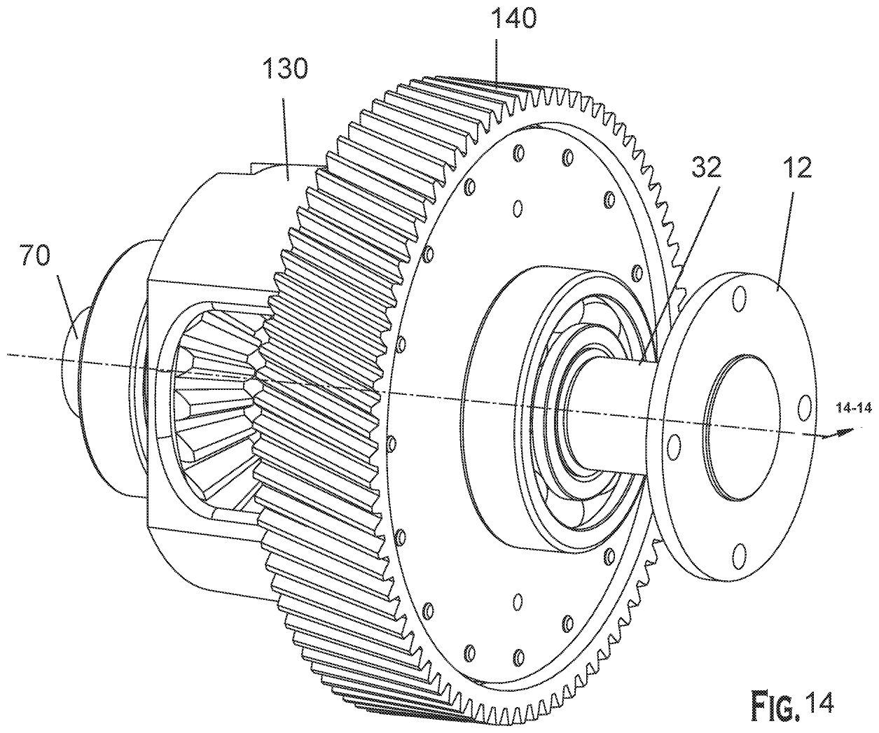

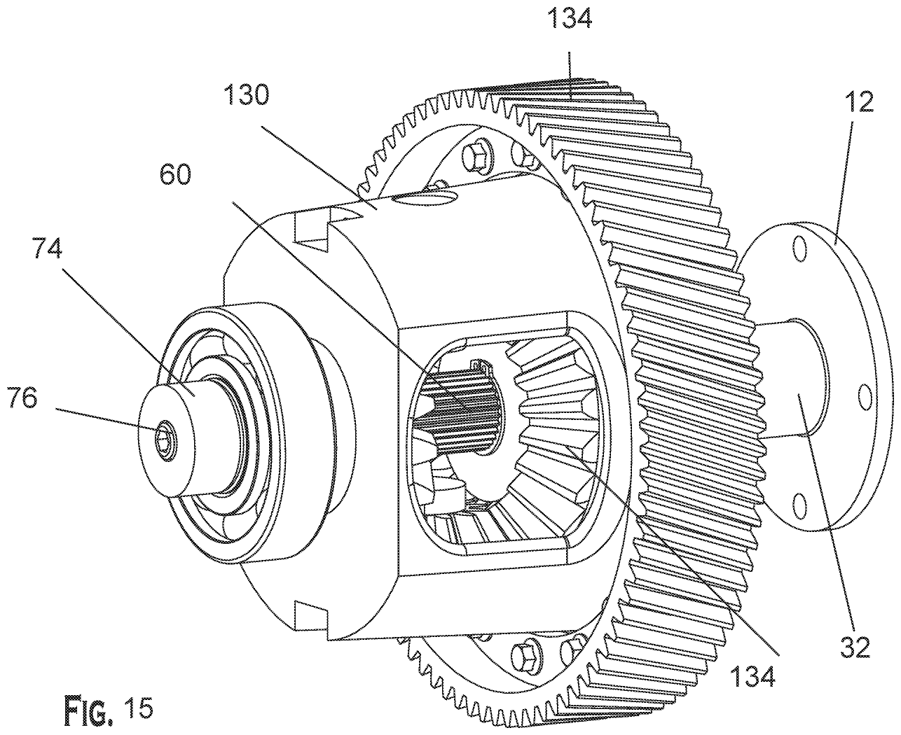

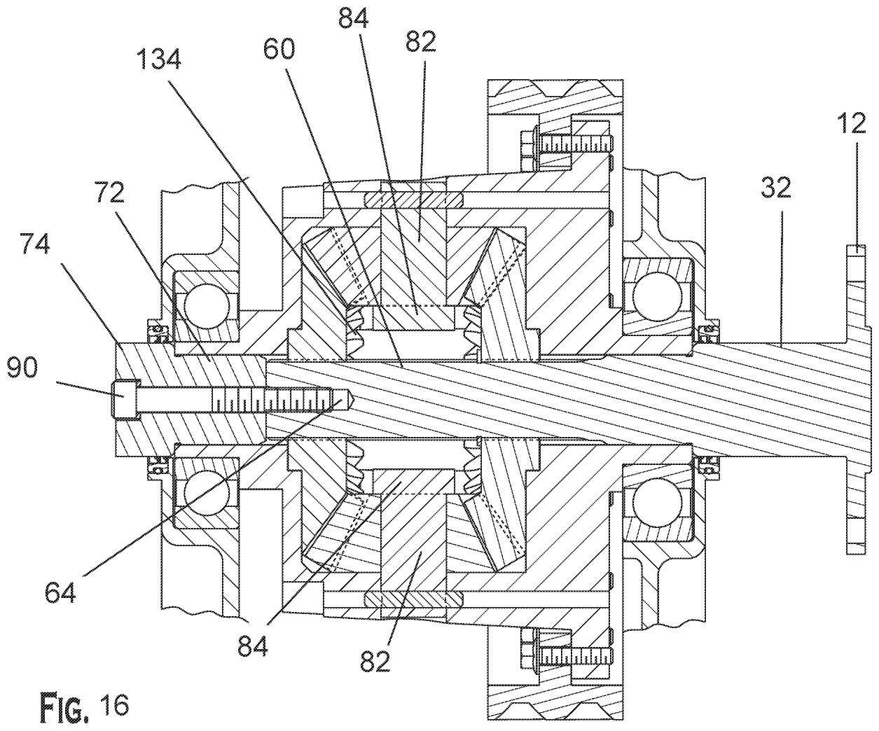

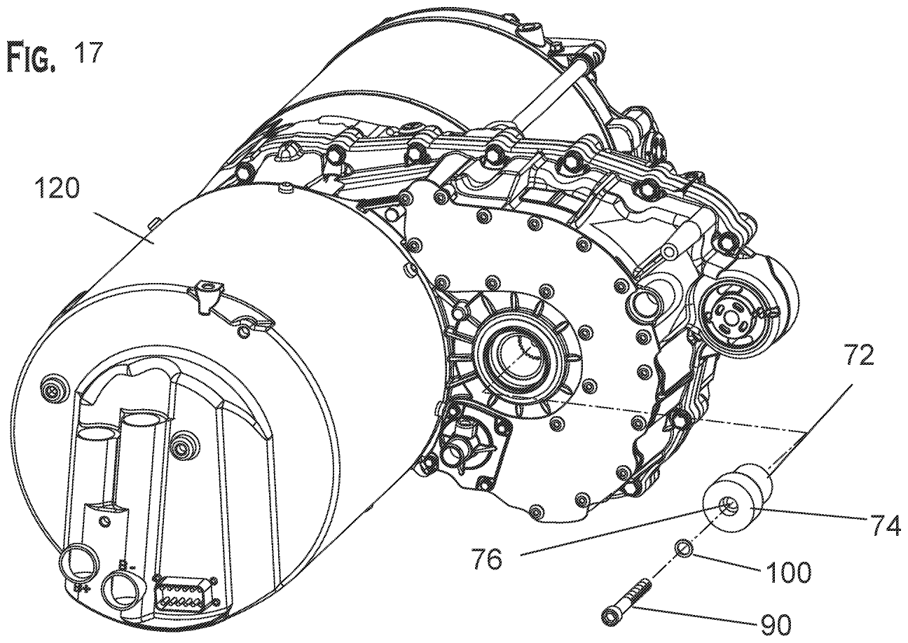

With reference to the FIGS. 2-17, a drive train conversion assembly 1 according to the invention is shown. In the exemplary embodiment, the drive train conversion assembly 1 generally includes a conversion assembly 2 and a locking assembly 4.

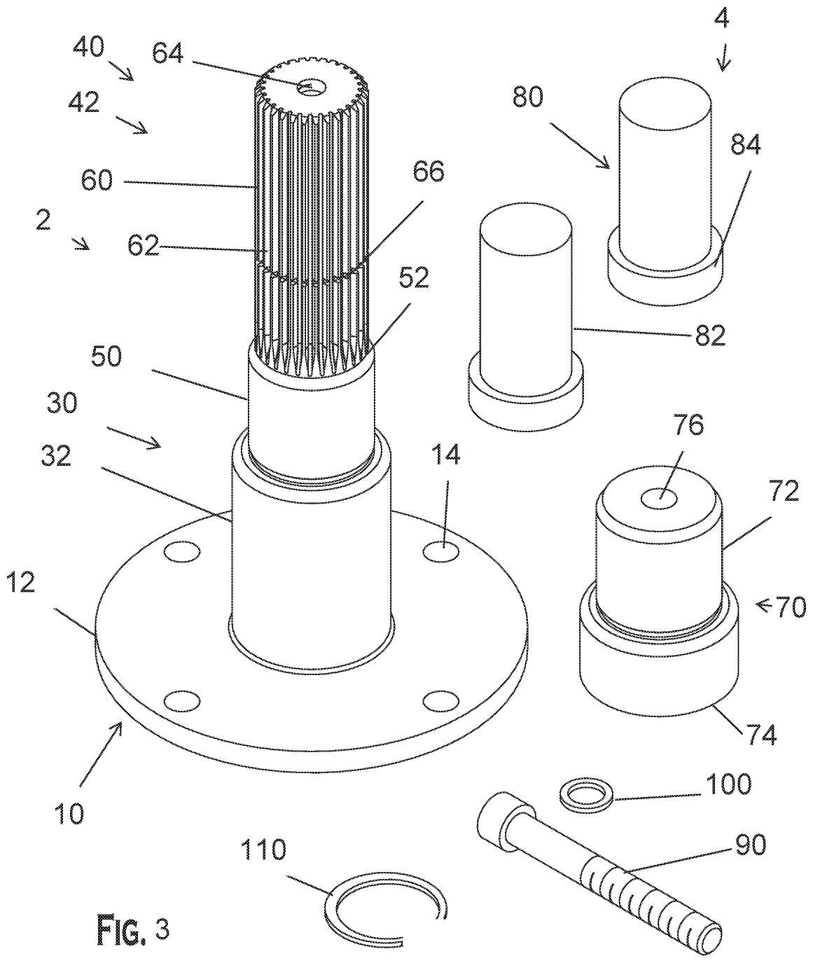

The conversion assembly 2 includes a base portion 10, a body portion 30 and a top portion 40 as shown in FIG. 3-10.

As shown, in an exemplary embodiment, the base portion 10 includes an end member 12. The end member 12 is a circular disk. The end member 12 further includes a plurality of passageways 14 extending through the end member 12 and around a circumference of the end member 12.

As shown, the base portion 10 further includes a base cap 20. The base cap 20 is a circular disk with a circumference less than the circumference of the end member 12. The base cap 20 is positioned under the end member 12.

As shown, the body portion 30 includes a joining member 32. The joining member 32 is cylindrically elongated. The joining member 32 is positioned abutting an upper portion of the end member 12. The joining member 32 is further positioned abutting a lower portion of an insertion member 42. Specifically, a lower portion of a connection member 50.

As shown, the top portion 40 includes the insertion member 42. The insertion member 42 generally includes the connection member 50 and a spline member 60.

As shown, the connection member 50 is a cylindrical body. The connection member 50 has a circumference less than the circumference of the joining member 32. The connection member 50 further includes a spline receiver 52 extending the circumference of the connection member 50. The spline receiver 52 is a raised circular incline.

As shown, the spline member 60 is an elongated cylinder positioned abutting an upper portion of the connection member 50. Specifically, the spline member 60 is positioned against the spline receiver 52. The spline member 60 further includes a plurality of teeth 62. The plurality of teeth 62 extend the length of the insertion member 42 and further extend a circumference of the spline member 60. The spline member 60 further includes a bolt receiver 64. The bolt receiver 64 is a threaded passageway extending into the spline member 60. The spline member 60 further includes a spline gap 66 positioned in a central region of the spline member 60. The spline gap 66 is a u-shaped gap within each individual tooth of the plurality of teeth 62 extending the circumference of the spline member 60.

As shown, the locking assembly 4 includes a stabilizer 70, a pair of pins 80, a bolt 90, a nut 100 and a c-clip 110.

The stabilizer 70 is a cylindrical member. A lower part of the cylindrical member 72 has a circumference equal to a circumference of the spline member 60. An upper part of the cylindrical member 74 has a circumference greater than the lower part 72. The stabilizer 70 further includes a locking receiver 76. The locking receiver 76 is a threaded passage extending through both the upper part 74 and the lower part 72 of the stabilizer 70.

The pair of pins 80 include a rod member 82. The rod member 82 is elongated with a bulbous head portion 84. The bulbous head portion 84 has a circumference greater than a circumference of the rod member 82.

The bolt 90 is a standard bolt or fastener, one of ordinary skill in the art would understand the applicant's design is not the exclusive embodiment.

The nut 100 is a standard nut positioned through the bolt 90. One skilled in art would understand the applicant's design is not the exclusive embodiment.

The c-clip 110 is a standard c-clip. One skilled in the art would understand the applicant's design is not the exclusive embodiment.

As shown in FIG. 2, a user will remove the gas motor and install the electric motor into the vehicle. The electric motor will be inverted and positioned parallel with respect to the drive train conversion assembly 1. When the user is ready to install the drive train conversion assembly 1 into the electric vehicle, the user will position the c-clip 110 on the spline gap 66. The user will then slide the spline member 60 into and through a spider cage 130 of an electric vehicle engine 120. The spline member 60 will marry with a universal key passageway 132 within the spider cage 130. The c-clip 110 causes interference and resistance upon inserting the spline member 60 as it is compressed. The c-clip 110 then expands once the spline member 60 is positioned within the spider cage 130. The c-clip 110 acts as a safety measure preventing the spline member 60 from accidentally being pulled out of the spider cage 130. The spline member 60 will extend and connect with a rotary drive train 140 within the electric vehicle engine 120. Each pin of the pair of pins 80 are positioned on opposite sides of the spider cage 130 in a respective slot 133. The pair of pins 80 are not interchangeable and each pin 80 is only permitted into its respective slot 133. One skilled in the art would understand the applicant's design is not the exclusive embodiment. Once each pin 80 is inserted into its respective slot 133, the pins 80 contact a plurality of sprockets 134. The bulbous head portion 84 of the pins 80 prevent the pins 80 from releasing while the electric vehicle engine 120 is in use. The user will then align the locking receiver 76 of the stabilizer 70 with the bolt receiver 64 of the spline member 60. The bolt or fastener 90 is then threaded through both the locking receiver 76 and bolt receiver 64, securing the conversion assembly 2 within the electric vehicle engine 120. The conversion assembly 2, specifically the spline member 60 prevents movement of the plurality of sprockets 134. The user will then be able to manipulate the gear ratio of the rotary drive train 140 within the electric vehicle engine 120 to adjust for the conversion of an electric powered motor.

Additionally, the user will couple the end member 12 to the drive shaft as shown in FIG. 2. Specifically, the user will utilize the plurality of passageways 14 to couple to the drive shaft.

It should be noted that various changes and modifications to the embodiments described herein will be apparent to those skilled in the art. Such changes and modifications may be made without departing from the spirit and scope of the present invention and without diminishing its intended advantages. For example, various embodiments may be provided based on various combinations of the features and functions from the subject matter provided herein.

What is claimed is:

1. A drive train conversion assembly comprising:
an end member;
a joining member positioned abutting an upper portion of the end member;
a connection member coupled to an upper portion of the joining member; and
a spline member connected to the connection member and having a plurality of teeth marrying a universal key receiver of a spider cage.

2. The drive train conversion assembly of claim 1, wherein the spline member further includes a bolt receiver.

3. The drive train conversion assembly of claim 2 wherein the drive train conversion assembly further comprises a stabilizer.

4. The drive train conversion assembly of claim 3, wherein the stabilizer includes a locking receiver.

5. The drive train conversion assembly of claim 4, wherein the stabilizer couples to the spline member.

6. The drive train conversion assembly of claim 5, wherein the drive train conversion assembly further comprises a base cap positioned under the end member.

7. The drive train conversion assembly of claim 6, wherein the end member further includes a plurality of passageways positioned around a circumference of the end member.

8. The drive train conversion assembly of claim 7, wherein the connection member has a circumference less than a circumference of the joining member.

9. The drive train conversion assembly of claim 8, wherein the spline member is an elongated cylinder abutting an upper portion of the connection member.

10. The drive train conversion assembly of claim 9, wherein the spline member further includes a spline gap positioned in a central region of the spline member.

11. The drive train conversion assembly of claim 10, wherein a lower part of the stabilizer has a circumference equal to the spline member.

12. The drive train conversion assembly of claim 11, wherein an upper part of the stabilizer has a circumference greater than the lower part of the stabilizer.

13. The drive train conversion assembly of claim 12, wherein the drive train conversion assembly further comprises a pair of pins.

14. The drive train conversion assembly of claim 13, wherein each pin of the pair of pins includes a rod member with a bulbous head portion.

15. The drive train conversion assembly of claim 14, wherein the drive train conversion assembly further comprises a c-clip.

16. The drive train conversion assembly of claim 15, wherein the spline member extends through the spider cage and couples with a rotatory drive train.

17. The drive train conversion assembly of claim 16, wherein the pair of pins are positioned on opposing ends of the spider cage.

18. The drive train conversion assembly of claim 17, wherein the locking receiver of the stabilizer aligns with the bolt receiver of the spline member.

19. The drive train conversion assembly of claim 18, wherein the spline member is positioned against a spline receiver of the connection member.

20. The drive train conversion assembly of claim 19, wherein a fastener is threaded through both the locking receiver and the bolt receiver.
